(19) United States
(12) Patent Application Publication
(10) Pub. No.: US 2011/0093147 A1
(43) Pub. Date: Apr. 21, 2011

(54) METHOD AND DEVICE FOR OPERATING A HYBRID DRIVE OF A VEHICLE

(76) Inventors: Johannes Kaltenbach, Friedrichshafen (DE); Stefan Wallner, Mattsee (AT)

(21) Appl. No.: 12/808,641

(22) PCT Filed: Dec. 2, 2008
(86) PCT No.: PCT/EP2008/066599

§ 371 Date: Dec. 2, 2010

(30) Foreign Application Priority Data
Dec. 17, 2007 (DE) 10 2007 055 830.0

(51) Int. Cl. B60W 20/00; B60W 10/02; B60W 10/06; B60W 10/08

(52) U.S. Cl. 701/22; 180/65.265; 903/902

(57) ABSTRACT

The invention relates to a method and a device for operating a hybrid drive (1) of a vehicle, comprising a drive train (2) substantially having an internal combustion engine (3), an electrical machine (5), an activatable clutch (4) by means of which the internal combustion engine (3) can be frictionally connected to the electrical machine (5), and a powershift transmission (7). The aim of the invention is to allow a simple and efficient control of a starting process of the internal combustion engine (3) by means of the electrical machine (5) during shifting and to guarantee a high degree of operating ease of the hybrid drive (1). When the vehicle travels electromotively with the clutch (4) open, in order to start the internal combustion engine (3) by means of the electrical machine (5) during a power shift, the control of the electrical machine (5) to generate a reduced dynamic torque curve (26) at the input of the powershift transmission (7) is replaced by a control of the clutch (4) with a dynamic torque curve (29) that acts on the internal combustion engine (3) and has an inverse value.

The invention concerns a process and a system for the operation of a hybrid drive in a vehicle according to the preamble of patent claim 1 and/or patent claim 6.

Hybrid drives are increasingly important in vehicle manufacture due to their potential for reducing emissions of hazardous materials and energy consumption. Such vehicles have different types of drive power sources, whereby combinations of internal combustion engines and electric motors are advantageous because they can utilize the range and power advantages of internal combustion engines on the one hand and the flexible applications of electric motors on the other as sole or auxiliary power source or as a starter/generator and a generator for electrical power and recovery.

The market require hybrid drive trains that can be implemented in vehicles, if possible, without additional space requirements, with as little complexity as possible, and at low cost and design effort. There is a basic distinction between so-called series hybrids and parallel hybrids as hybrid topologies for vehicle drives. Such drive arrangements are already known and are continually further developed.

In the series hybrid, the drive motors are connected one after the other in terms of drive technology. Here, the internal combustion engine, for example a diesel engine, serves as the drive for a generator that in turn drives an electric motor. The vehicle is exclusively driven by the electric motor. The internal combustion engine is decoupled from the drive wheels and can therefore always be operated a single operating point, that is, at a certain torque and constant speed. This drive concept is suitable for buses in short-range city traffic, for example, where an operating point can be chosen at which the efficiency of the internal combustion engine is as high as possible, while hazardous waste emission, fuel consumption, and noise lie in a favorable range. On the other hand, the series hybrid has the disadvantage that the efficiency of the drive is restricted due to multiple conversions between mechanical and electrical power.

In contrast, parallel hybrid drive trains, due to an arrangement of drive train assemblies that is parallel in terms of power flow, offer in addition to the overlapping of drive torques the option of control using purely internal combustion drive or purely electrical drive. Basically, in the parallel hybrid the internal combustion engine can largely be operated at its optimum torque by loading and/or supporting one or more electrical motors, so that the maximum efficiency of the internal combustion engine can be used effectively. This support of the internal combustion engine reduces fuel consumption on average. Since temporary increases in power requirements in so-called “boost mode”, for example during passing, permit the drive powers to be added together, the internal combustion engine can be comparatively small, saving weight and space with nearly no penalties in terms of vehicle performance or comfort, with resulting savings in emissions and cost. The electric motor can also function as an integrated starter generator (ISG) to start the internal combustion engine using a clutch. The electrical motor is also used in generator mode to charge an electrical power store and can be used for recovery. Any type of vehicle transmission can be used to vary the gear transmission ratio of the drive to the driven axis.

The goal of numerous developments in hybrid drive company is operational strategies on the one hand to make use of existing hybrid components depending on the driving situation while largely considering driver wishes, while using them in as effective and energy-saving manner as possible while preserving a high degree of driver comfort. Selected developments are listed below.

DE 10 2004 043 589 A1 includes such an operating strategy in a parallel hybrid drive train, for example in combination with the 6HP26 6-gear automatic transmission known from the applicant's production series, in which a target charge state of an electrical energy store is determined based a more sporty or more economic driving style. The drive performance is distributed over the hybrid assemblies in accordance with the momentary drive requirements of the driver in such a way that this target charge is maintained. A particularly sporty driving style requires the energy store to be maintained close to full capacity at all times in order to provide the total power of the drive assemblies during boosting. A more economical driving style, on the other hand, often requires the energy store to be exhausted in order to utilize the incoming recovery power effectively to charge the store.

WO 2006 111 434 A1 discloses a process by means of which an electric motor and an internal combustion engine generate a required target torque together, whereby a momentary torque reserve is taken into consideration in the electric motor in order to minimize a given torque reserve in the internal combustion engine.

WO 2007 020 130 A1 discloses a process for recovery in a hybrid vehicle whereby the portion of braking torque in the electric motor during speed reduction is coordinated with a brake pressure exerted by the driver.

U.S. Pat. No. 7,174,980 B2 discloses a process for the control of a hybrid drive in which an electric motor is used to prevent sudden changes in drag torque, and depending on requirements, influencing the drag torque characteristic of the entire hybrid drive.

DE 10 2005 044 828 A1 describes a process for the calculation of the optimum operating point of a hybrid drive, whereby a torque requested by the driver on the one hand and a dynamic behavior of existing vehicle assemblies on the other hand, e.g. a so-called turbo gap, are taken into consideration. A optimization algorithm is suggested in which previously determined parameters and current conditions such as the momentary position of the accelerator and the current speed of the vehicle are used to affect variables such as the distribution of torque between drive assemblies and the gear transmission ratio.

DE 10 2005 044 268 A1 discloses a process in which the charge state of an energy store and/or an energy flow (drive power/electric power) in the vehicle is regulated depending on a cost function for energy consumption or hazardous waste emission in order to increase the efficiency of a hybrid drive.

In DE 699 32 487 T2, a process is described for the regulation and monitoring of the charge state of an electrical energy store in a hybrid vehicle, whereby even in case of insufficiency recovery in certain driving situations, for example in case of repeated successive acceleration and braking or in case of driving up a slope that does not immediately follow a downhill slope, sufficient charge in the store is assured.

Finally, DE 10 2005 049 458 A1 recommends a forward-looking strategy in the operation of a vehicle with a hybrid drive, in which digital maps, location systems, and location-specific speed distributions stored in time/space traffic patterns are all used to make decisions about the engagement or disengagement of a hybrid assembly for the specific stretch of road.

In a hybrid vehicle, effortless switching between drive modes during driving is particularly important. Starts of the internal combustion motor from pure electric drive, particularly frequent in city driving, should take place reliably and conveniently, where possible without jerks in the drive train. A switching strategy and a hybrid operation strategy can be correlated in such a way that a shift requirement coincides with a motor start request in certain operating situations.

In a common design for a parallel hybrid drive, disclosed for example in US 2005 022 1947 A1, the internal combustion engine can be coupled with an electric motor using a first clutch. The electric motor can be connected to a transmission using a second clutch. The internal combustion engine can be started by the electric motor during a gear shift in the context of a stop/stop function. First, during a stop step, the internal combustion engine is disconnected from the remainder of the drive train and turned off, by means of a controller when specific stop conditions occur, for example when slowing at a traffic light or in a traffic jam. During the subsequent start step, the electric motor first drives the vehicle with a first transmission gear ratio engaged. Then the drive train controller changes (increases) the transmission gear ratio when specific operating conditions occur, while simultaneously the electric motor is separated from the transmission using the clutch on the transmission side and the internal combustion engine's clutch is engaged, so that the internal combustion engine is started by the electric motor. After the start is complete, the internal combustion engine is connected to the transmission by the transmission clutch, so that the internal combustion engine drives the vehicle alone or in combination with the electric motor.

The internal combustion engine can taken place during a gear shift, but the electric motor must be disconnected from the transmission using a suitable clutch, whereby an interruption in power occurs that is perceived as disadvantageous.

A particularly simple hybrid drive train, on the other hand, is disclosed by DE 10 2005 051 382 A1. In this arrangement, only a friction-resistant or particularly cost-effective and compact shaped clutch is provided that can be used to connect an internal combustion engine with an electric motor. No second clutch between the electric motor and a downstream transmission is required. The electric motor can thus directly exert a positive (motor operation) or negative (generator operation) torque on a transmission input shaft for the gear shifting assembly. The transmission can be an automatic power-shift transmission, for example, that is a discrete or continuous transmission in which changes in gear transmission ratio are largely free of power interruptions, that is, can take place under load using automatically controlled shifting elements such as lamellar clutches or band brakes. To start the internal combustion motor in electric drive, the transmission must first be in a neutral position or be placed into neutral. The clutch is then engaged in the closing direction, so that the electric motor exerts a positive torque on the internal combustion engine in its preferred rotational direction, starting it.

The second clutch can be omitted, since the neutral position largely decouples the internal combustion engine from the take-off shaft of the transmission during the start process. However, engagement of a desired gear transmission ratio can only take place after the internal combustion engine starts, so the overall gear shifting process is slowed.

It is also a known technique in a drive train with a power shift transmission to reduce the drive torque of a drive assembly engaged with the transmission while shifting up under power in order to avoid a torque overload on the take-off side that would occur during up-shifting due to the mass inertia of the rotating transmission parts according to the equation M=J×dw/dt, where J is the moment of inertia and dw/dt is the angular acceleration. A corresponding negative torque application on the drive assembly, that is, a temporary reduction of its drive torque, is required for this reason.

In a hybrid drive with a power shift transmission in the described one-clutch arrangement (1C-ISG) or two-clutch arrangement (2C-ISG) with an integrated starter generator function of the electric motor, in an up-shift under power during electric drive the electric drive torque on the electric motor must thus be correspondingly reduced. If an engine start is simultaneously planned using the electric motor during the power shift, the problem arises that different mutually interfering operating parameters, particularly a slack time in the shift clutches during the gear shift, a torque introduced by the electric motor while the transmission is shifting, a torque introduced by the electric motor while shifting via the clutch on the crankshaft of the internal combustion engine, or the time behavior of gear shifts and engine start, must be coordinated in order to ensure the most comfortable, low-wear hybrid operation possible.

In this context, the object of the invention is to specify a process and system for the operation of a hybrid drive with an internal combustion engine, an electric motor, and a power shift transmission that, when starting an internal combustion engine during purely electric operation during a power shift of a power shift transmission, ensures a reliable start process and simultaneously a high degree of operating comfort.

The solution of this task results from the characteristics of the independent claims, while advantageous embodiments and further development of the invention can be found in the subordinate claims.

The invention is based on the recognition that in a hybrid vehicle with a power shift transmission, the transition from electric operation to internal combustion operation during a transmission shift can be carried out reliably and comfortably by adapting the slack time of the transmission to the starting process of the internal combustion engine.

The invention thus assumes a process for the operation of a hybrid drive of a vehicle with a drive train comprising primarily an internal combustion engine, an electric motor, a controllable clutch that can connect the internal combustion engine with the electric motor, and a power shift transmission. A “power shift transmission” is an automatic transmission that shifts at least nearly free of any interruption in drive power.

To solve the task, the invention provides that, assuming electric motor drive with the clutch open, to start the internal combustion engine using the electric motor during a power shift, control of the electric motor to generate a reduced dynamic torque behavior on the input of the power shift transmission is replaced by controlling the clutch with a dynamic torque behavior acting on the internal combustion engine with an inverse amplitude.

This control procedure has the advantage of providing simplified configuration and a particularly efficient use of the electric drive during gear shifting and the simultaneous start of the internal combustion engine.

The described task is also solved by a system to perform the process.

The invention thus also assumes a system for the operation of a hybrid drive of a vehicle with a drive train comprising primarily an internal combustion engine, an electric motor, a controllable clutch that can connect the internal combustion engine with the electric motor, and a power shift transmission.

Control means are also provided by means of which the clutch can be controlled in such a way that with at least largely constant drive torque in the electric motor a reduced dynamic torque behavior of the power shift transmission needed for performance of a power shift can be generated and the internal combustion engine can be started using the torque transmitted through the clutch.

The invention makes use of the fact that during up-shifting of a power shift transmission under power the drive torque of the drive assembly is generally reduced in order to avoid undesired torque increases on the take-off side. During electric drive of a hybrid vehicle, the electric drive torque must correspondingly be reduced at the start of the shift procedure and increased again at the end of the shift procedure, in order to enable smooth gear shifts without additional jerk in the drive train.

If the hybrid strategy and/or a drive request means that the internal combustion engine should be started during such a power shift in electric drive, then instead of a reduction in the electrically generated torque corresponding to the required negative torque intervention in the transmission, the drive torque of the electric motor can be held constant and the clutch between the internal combustion engine and the electric motor can be actuated in the closing direction in such a way that this dynamic torque behavior is assumed by the clutch and transmitted to the crankshaft as torque. This means that the required torque behavior on the transmission input, reduced in amplitude, is generated due to the fact that the clutch is at least partly closed or engaged by a clutch controller with appropriate behavior.

Since the dynamic torque behavior thus transmitted from the electric motor and the rotating components of the transmission to the clutch correspond to the torque behavior adapted to the power shift, this clutch actuation preferably takes place synchronously with the shift control of the power shift transmission. This prevents problems with the control of engine starts and power shifts. The duration of the torque intervention preferably corresponds to the so-called slack time of the shift clutches in the power shift transmission, that is, the period during which either one or both of the engaging and disengaging transmission-internal shift clutches are in slack for shifting of the cooperating transmission linkages. Since the engine start time falls within this slack time, the take-off is largely decoupled from the internal combustion motor during engine start, reliably preventing jerks in the drive train, ensuring and/or increasing the desired driving comfort.

Control of the shifting procedure itself can preferably be taken without modification from a conventional transmission controller. Only a suitable clutch controller communicating with the hybrid controllers need be implemented.

In the simplest case, the dynamic torque of the power up-shifting that is more or less stored in the inertia of the drive train largely suffices to start the engine, so that the torque on the electric motor can be kept constant and thus is particularly easy to configure.

If the dynamic torque corresponding to the reduced torque behavior of the power shift transmission and delivered to the clutch is insufficient to start the internal combustion engine, control measures for actuation of the clutch and/or the electric motor in addition to substitution of the torque behavior can be provided.

Since the dynamic torque available depends on the size of the transmission ratio in the power shift transmission, it can be advantageous instead of the usual sequential shift to skip one or more gears in the power shift transmission in order to start the internal combustion engine reliably. For example, a shift from first gear to third gear may be carried out. The electric drive torque can again be kept constant.

As a further control measure to ensure the startability of the internal combustion engine, it may be provided that in addition to the substitution of the torque behavior, synchronous actuation of the electric motor and the clutch can increase a drive torque on the electric motor and a torque transmitted by the clutch to the internal combustion engine during simultaneous start of the internal combustion engine and the power shift transmission by the same predetermined amount.

To clarify the invention, the description of a drawing of an embodiment is attached. In this,

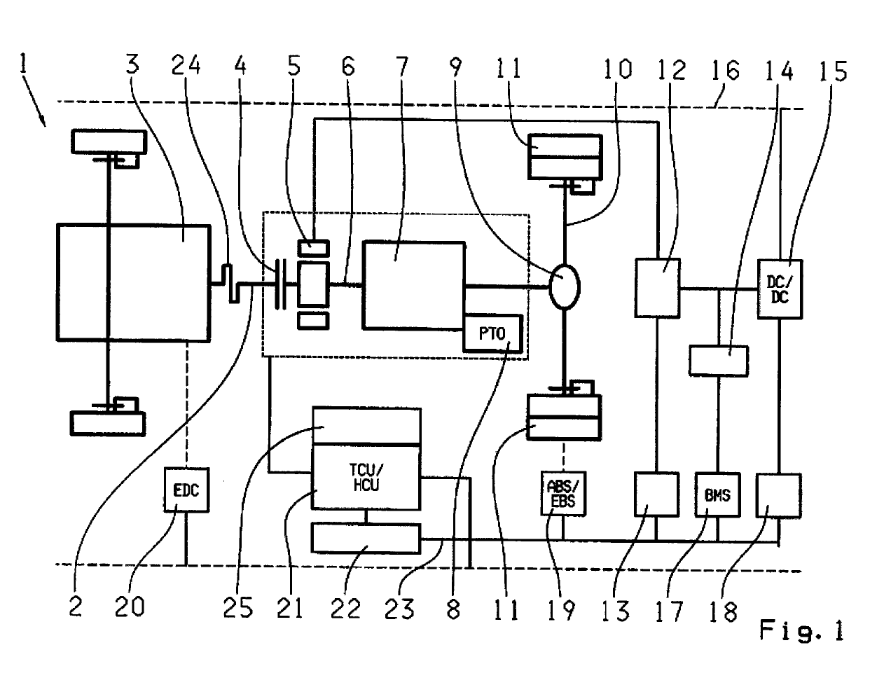

FIG. 1 shows a schematic of a vehicle hybrid drive for performance of a process according to the invention,

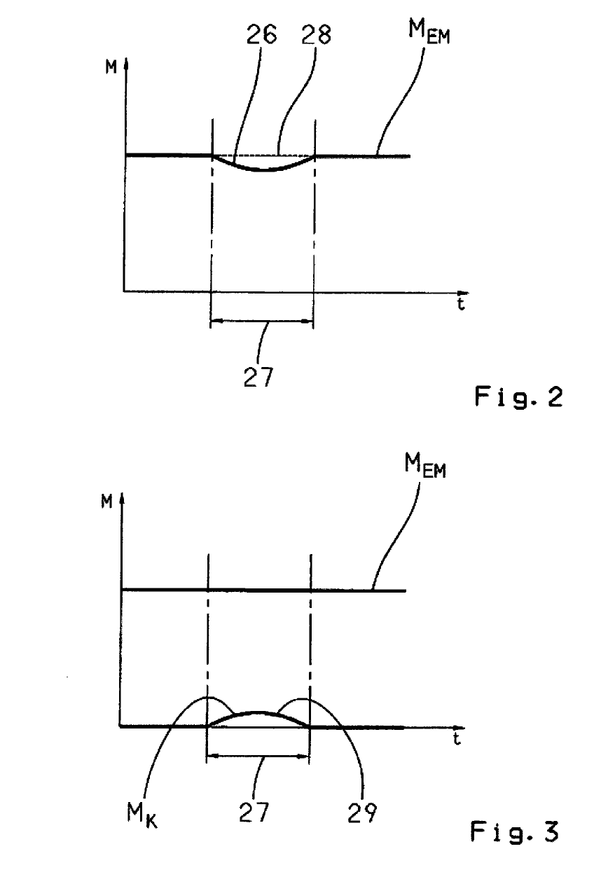

FIG. 2 shows a torque behavior in a power shift transmission without starting the engine, and

FIG. 3 shows a torque behavior in a power shift transmission while starting the engine.

Thus FIG. 1 shows a schematic of a vehicle hybrid drive 1 with a parallel hybrid drive train 2, as might be provided for a utility vehicle, for example (truck, bus, specialized vehicle). The structure of such a drive train 2 is already familiar to the expert. Drive train 2 has an internal combustion engine 3, for example a diesel engine with a crankshaft 24, which can be connected to an electric motor 5 by means of a first clutch 4 implemented as a friction clutch. The significant feature for the invention is a controller for the drive train 2 according to the invention, particularly of clutch 4 and the electric motor 5.

The electric motor 5 is downstream from a power shift transmission 7. Electric motor 5 is connected to power shift transmission 7 by means of a second clutch or transmission-internal shift elements not further shown or explained. For simplicity's sake, FIG. 1 shows only a transmission input shaft 6 as a connecting element for torque transmission between electric motor 5 and the power shift transmission 7.

Downstream of power shift transmission 7, an auxiliary take-off (PTO: Power Take-Off) 8, not explained further, can also be provided. Transmission 7 and a differential 9 can also be used in a conventional manner to direct the applied torque of hybrid drive 1 to a drive axle 10 and further to the drive wheels 11.

Depending on the operating situation, electric motor 5 can be operated as an electrical drive assembly or as a generator. To this end, it is connected to an electrical inverter 12 that can be controlled by an inverter controller 13. Through inverter 12, electric motor 5 is connected to an electrical drive energy store 14, for example a 340V high-voltage battery. In motor operation, electric motor 5 is supplied by energy store 14. In generator operation, that is, when driven by internal combustion engine 3 and/or in recovery mode, the energy store 14 is charged by electric motor 5. Furthermore, electric motor 5 functions as an integrated starter generator (ISG) to start internal combustion engine 3.

The high-voltage circuit of energy store 14 and/or the controller connected to it are connected to an on-board network (24V or 12V) 16 through a bidirectional direct-current converter (DC/DC). Energy store 14 can be monitored and controlled by a battery management system 17 with respect to its state of charge (SOC). Direct-current converter 15 can be controlled by a direct-current converter controller 18. Moreover, a controller 19 is provided for brake regulation functions not explained in further detail, particularly an anti-lock brake system (ABS) and/or an electronic brake system (EBS) as well as another controller 20 for electronic diesel control (EDC) for internal combustion engine 3, implemented as a diesel engine, for example. The controllers listed individually can also at least partly be combined into a single controller.

Moreover, an integrated control system 21 is provided, primarily combining the functions of a transmission control unit (TCU), a hybrid control unit (HCU), and different operating functions. Control system 21 is assigned controllers, particularly a control unit 25, for the control of at least one actuator of clutch 4, which may also be integrated into control system 21.

The specific drive energy distribution and functional control of the individual components of the hybrid drive can be controlled by means of a central strategic unit 22, which is preferably connected by means of a data bus 23 (e.g. CAN) to control system 21 and control unit 25 as well as the relevant controllers 13, 17, 18, 19.

A process according to the invention that can be carried out with the indicated hybrid drive 1 is based on the use of a dynamic torque in a power shift transmission to start the internal combustion engine 3.

For further clarification, FIG. 2 shows a co drive torque behavior M_{EM} of electric motor 5 in a power shift transmission without engine start. In the power shift transmission, during a period 27 of electric drive, the electric motor 5 is directed by control system 21 to exhibit a drive torque reduction 26, corresponding to a predefined reduction in dynamic torque behavior in the power shift transmission 7. A correspondingly freed shift torque is compensated in such a way that no undesired torque spikes occur on the transmission output. In comparison, a constant behavior 28 of the drive torque is shown as a driver requested torque.

FIG. 3 shows a torque behavior according to the invention for electric motor 5 and clutch 4 during a power shift and simultaneous start of the internal combustion engine 3. The drive torque M_{EM} of electric motor 5 is thus held constant as specified by the invention. Moreover, a particular torque behavior M_{K} of clutch 4 is configured by actuating it in a slack position. During period 27, thus largely simultaneous with the power shift, a drive torque 29 inverse to the drive torque reduction 26 in FIG. 2 is transmitted to clutch 4 during actuation of the clutch in the closing direction. Subsequently, internal combustion engine 3 is started with this drive torque 29, while simultaneously the reduced dynamic torque behavior is generated with constant electric drive torque M_{EM} on power shift transmission 7 together with the inverse drive torque 29 needed for comfortable shifting.

### LIST OF REFERENCE NUMBERS

1 Hybrid drive

2 Drive train

3 Internal combustion engine

4 Clutch

5 Electric motor

6 Transmission input shaft

7 Power shift transmission

8 Auxiliary transmission

9 Differential

10 Drive axle

11 Vehicle wheel

12 Inverter

13 Converter control unit

14 Electric drive energy store

15 Direct-current converter

16 On-board network

17 Battery management system

18 Voltage converter controller

19 Electronic brake controller

20 Electronic diesel controller

21 Control system

22 Operating strategy unit

23 Data bus

24 Crankshaft

25 Clutch control unit

26 Behavior of drive torque reduction

27 Shifting period

28 Driver request torque

29 Behavior of the clutch torque

M Drive torque

M_{EM} Torque behavior of electric motor

M_{K} Torque behavior of clutch

t Time

1. A process for the operation of a hybrid drive (1) of a vehicle, with a drive train (2) primarily comprising an internal combustion engine (3), an electric motor (5), a controllable clutch (4) by means of which the internal combustion engine (3) can be connected to the electric motor (5), and a power shift transmission (7), characterized by the fact that, assuming electric drive with the clutch (4) open, to start the internal combustion engine (3) using the electric motor (5) during a power shift, an actuation of the electric motor (5) to generate a reduced dynamic torque behavior (26) on the input of the power shift transmission (7) is substituted by an actuation of the clutch (4) with a dynamic torque behavior (29) acting on the internal combustion engine (3) with an inverse amplitude.

2. The process according to claim 1, characterized by the fact that during the simultaneous start of the internal combustion engine (3) and the performance of the power shift, a constant drive torque (M_{EM}) is maintained or set on the electric motor (5).

3. The process according to claim 1, characterized by the fact that that in addition to the substitution of the torque behavior, control measures for actuation of the clutch (4) and/or the electric motor (5) are provided if the dynamic torque transmitted to the clutch (4) corresponding to the reduced torque behavior of the power shift transmission is insufficient to start the internal combustion engine (3).

4. The process according to claim 3, characterized by the fact that by means of synchronous actuation of the electric motor (5) and the clutch (4) a drive torque of the electric motor (5) and a torque transmitted by the clutch (4) to the internal combustion engine (3) is increased by a predefined fixed amount during the simultaneous start of the internal combustion engine (3) and the power shift.

5. The process according to claim 3 4, characterized by the fact that during the power shift at least one gear level is skipped.

6. A system for the operation of a hybrid drive (1) of a vehicle, with a drive train (2) primarily comprising an internal combustion engine (3), an electric motor (5), a controllable clutch (4) by means of which the internal combustion engine (3) can be connected to the electric motor (5), and a power shift transmission (7), characterized by the fact that control means (25) are provided by means of which the clutch (4) can be controlled in such a way that for at least largely constant drive torque (M_{EM}) for the electric motor (5) a reduced dynamic torque behavior of the power shift transmission, needed for the performance of a power shift, can be generated, and the internal combustion engine (3) can be started using the torque (M_{K}) thus transmitted through clutch (4).
